(19) United States
(12) Patent Application Publication
(10) Pub. No.: US 2013/0070256 A1
(43) Pub. Date: Mar. 21, 2013

(54) MEASURING APPARATUS

(71) Applicant: Takumi Tokimitsu, Utsunomiya-shi (JP)

(72) Inventor: Takumi Tokimitsu, Utsunomiya-shi (JP)

(73) Assignee: CANON KABUSHIKI KAISHA, Tokyo (JP)

(21) Appl. No.: 13/611,156

(22) Filed: Sep. 12, 2012

(30) Foreign Application Priority Data
Sep. 20, 2011 (JP) 2011-204336

(51) Int. Cl. G01B 11/14

(52) U.S. Cl. 356/498

(57) ABSTRACT

A measuring apparatus includes a light source unit configured to continuously scan wavelengths of a plurality of types of beams at different speeds in a plurality of discrete wavelength scanning ranges, a beam synthesizer, an interferometer unit configured to detect as an interference signal an interference fringe formed by a reference beam reflected on a reference surface and a target beam reflected on a target surface, and a processor configured to determine the absolute distance based upon the interference signal detected by the interferometer unit. The interferometer unit includes a single optical detector. The processor obtains the absolute distance for each of the plurality of types of beams through a frequency analysis of a synthesized interference signal, and outputs one absolute distance by operating a plurality of absolute distances that have been obtained.

### BACKGROUND OF THE INVENTION

1. Field of the Invention

The present invention relates to a measuring apparatus configured to measure an absolute distance between a reference surface and a target surface.

2. Description of the Related Art

The wavelength scanning interferometer calculates an absolute distance between a reference surface and a target surface based upon variations with time of the intensity and phase of interference light obtained by scanning the wavelength of light emitted from a light source in terms of time. For the wavelength scanning interferometer, the measurement resolution and precision improve as the wavelength scanning range is made wider. Since the maximum measuring range depends upon the coherent length of the light emitted from the light source, it is effective to use of a single-mode laser configured to generate light having a long coherent length.

Chih-Che KUO, Kiyoshi. TAKAMASU, Akihiro. YAMAMOTO, Tomoyuki WADA, Kei SUNOUCHI, Kiwamu KASE and Hideo TASHIRO, “Signal Processing for Wavelength Scanning Interferometer,” precision engineering journal, vol. 69, no. 6, page 831 (2003) (“literature 1” hereinafter) proposes a wavelength scanning interferometer configured to obtain an absolute distance by detecting a peak of a modulation frequency through a fast Fourier transform (“FFT”) to an intensity of the interference light for each wavelength. Japanese Patent Laid-Open No. (“JP”) 2008-128707 discloses a wavelength scanning interference measuring method configured to widen an effective wavelength scanning range and to improve the resolution by scanning each of a plurality of discrete wavelength scanning ranges, utilizing a different light source.

However, the wavelength scanning interferometer disclosed in JP 2008-128707 causes a cost increase because it includes optical detectors equal in number to light sources because it utilizes the plurality of light sources and improves the precision. It is conceivable to use a single optical detector to sequentially measure an interference signal instead of simultaneous wavelength scans utilizing the plurality of light sources, but this approach would lower the measuring speed and cause a long measuring time.

### SUMMARY OF THE INVENTION

The present invention provides a measurement apparatus having a simple structure configured to provide a highly precise and fast measurement of an absolute distance between a reference surface and a target surface.

A measuring apparatus according to the present invention is configured to measure an absolute distance between a reference surface and a target surface. The measuring apparatus includes a light source unit configured to continuously scan wavelengths of a plurality of types of beams at different speeds in a plurality of discrete wavelength scanning ranges, a beam synthesizer configured to synthesize the plurality of types of beams emitted from the light source unit, an interferometer unit configured to split the beam synthesized by the beam synthesizer into a reference beam and a target beam and to detect as an interference signal an interference pattern (interference fringe) formed by the reference beam reflected on a reference surface and the target beam reflected on a target surface, and a processor configured to determine the absolute distance based upon the interference signal detected by the interferometer unit. The interferometer unit includes a single optical detector configured to detect each of a plurality of types of interference patterns corresponding to the plurality of types of beams, in a synthesized interference signal. The processor obtains the absolute distance for each of the plurality of types of beams through a frequency analysis of the synthesized interference signal, and outputs one absolute distance by operating a plurality of absolute distances that have been obtained.

Further features of the present invention will become apparent from the following description of exemplary embodiments with reference to the attached drawings.

### BRIEF DESCRIPTION OF THE DRAWINGS

FIG. 1 is a block diagram of a measuring apparatus (wavelength scanning interferometer) according to this embodiment.

FIG. 2 illustrates a wave number scanning range of three light sources illustrated in FIG. 1.

FIG. 3 is a flowchart for explaining an operation of a processor illustrated in FIG. 1.

FIGS. 4A and 4B illustrate an interference signal and an FFTed interference signal.

FIG. 5 is a flowchart for explaining an operation of the processor illustrated in FIG. 1.

FIGS. 6A and 6B illustrate an interference signal S1 and its phase.

FIG. 7 illustrates a method for calculating a slope of a phase.

FIG. 8 illustrates a method for calculating a slope of a phase.

### DESCRIPTION OF THE EMBODIMENTS

The measuring apparatus (wavelength scanning interferometer) of this embodiment is configured to provide a highly precise and fast measurement of an absolute position between a reference surface and a target surface, and includes a light source unit, a beam synthesizer (light flux synthesizer), an interferometer unit, and a processor.

The light source unit includes N (which is an integer of two or more) types of light sources configured to generate a plurality of beams (light fluxes) having N discrete wavelength scanning ranges (wave number scanning ranges) and to continuously scan the wave number, and drivers each of which is provided for each light source so as to scan a wave number of the light source. The driver scans the wavelength at a different speed for a single optical detector, which will be described later.

The beam synthesizer synthesizes a plurality of types of beams which are emitted from the light source unit and enter the single optical detector, which will be described later, and outputs a synthesized beam to an interferometer unit.

The interferometer unit splits an incident beam into a reference beam and a target beam, and detects as an interference signal an interference pattern formed by the reference beam reflected on the reference surface and the target beam reflected on the target surface. The interferometer unit detects the interference signal (beat signal) utilizing a single optical detector, and the interference signal is a detected signal of the interference pattern between the reference beam and the target beam in each wave number scanning range. Since the prior art optically splits the light fluxes from the different light sources and detects the interference signals, the prior art uses the optical detectors of the same number as the light sources. However, this embodiment introduces the light fluxes emitted from the plurality of light source unit to the same, single optical detector, and thus reduces the number of optical detectors. In that case, according to this embodiment, each light source scans the wavelength at a different speed so that the processor can separate the plurality of types of interference signals from one another. This embodiment can achieve high-speed measurements by simultaneously supplying a plurality of light fluxes to the optical detector.

Another optical detector may be provided in addition to this single optical detector. Even in this case, although the total number of the optical detectors is not one, the number of optical detectors is less than the number of light sources (the number of types of beams). For example, when three light sources are provided, two optical detectors may be provided.

The processor determines the absolute distance based upon the interference signal detected by the interferometer unit.

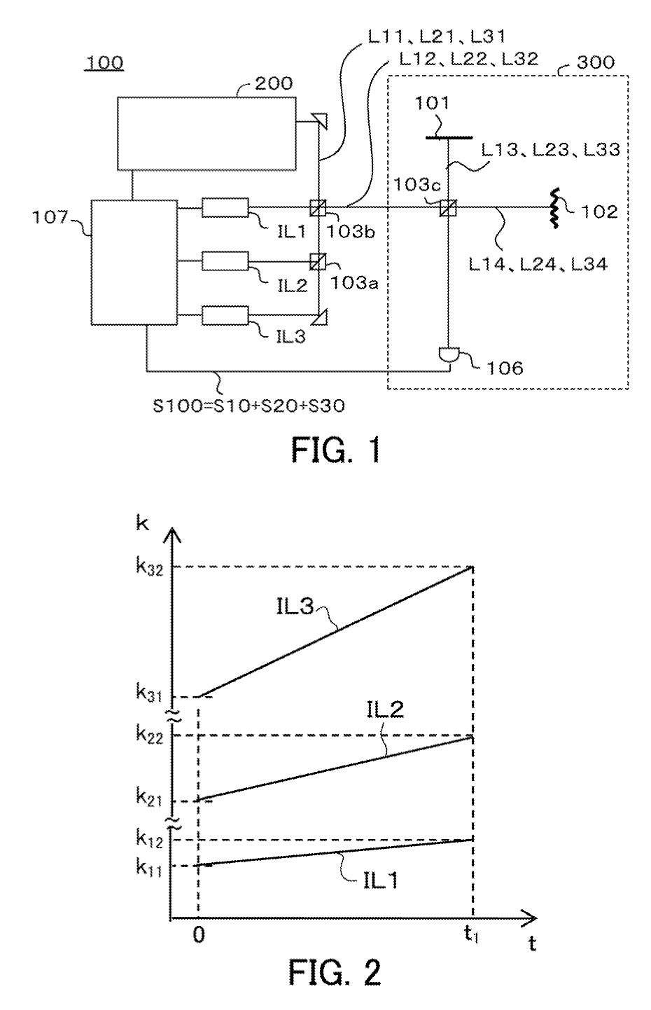

FIG. 1 is a block diagram of a measuring apparatus (wavelength scanning interferometer) 100 according to this embodiment. The measuring apparatus 100 calculates an absolute distance L that is an optical path length difference between a reference surface 101 and a target surface 102.

The measuring apparatus 100 includes a light source unit that includes three light sources IL1, IL2, and IL3 used to scan a plurality of (or three in this case) discrete wavelength scanning ranges. The light sources IL1, IL2, and IL3 may be semiconductor lasers, such as a vertical cavity surface emitting laser (“VCSEL”).

The processor 107 is a processor (microcomputer) configured to continuously change a wavelength of a beam emitted from each of the light sources IL1, IL2, and IL3 by changing a current supplied to corresponding drivers (not illustrated) in the light source unit. This embodiment sets different wavelength scanning speeds (wavelength scanning rates) to these three light sources so as to separate the FFTed frequencies used for the frequency analysis, which will be described later.

The light source IL1 scans a first wavelength scanning range from a wavelength λ₁₁ to a wavelength λ₁₂, the light source IL2 scans a second wavelength scanning range from a wavelength λ₂₁ to a wavelength λ₂₂, and the light source IL3 scans a third wavelength scanning range from a wavelength λ₃₁ to a wavelength λ₃₂, at simultaneous timings. At this time, it is sufficient that the wavelength scanning timings of the beams emitted from the three light sources overlap one another, and the simultaneous starting of the light emissions are unnecessary for the three light sources. The “simultaneous” requirement is effective to high-speed measurements because turning on of the light sources one by one will lower the measurement speed.

FIG. 2 illustrates wave number scanning ranges of the three light sources IL1, IL2, and IL3. An abscissa axis denotes time t, and an ordinate axis denotes a wave number k. Assume k is a wave number defined as k=2Π/λ where λ is a wavelength. Then, the light source IL1 scans a wave number scanning range from a wave number k₁₁ (=2Π/λ₁₁) to a wave number k₁₂ (=2Π/λ₁₂) between 0 and t₁. Similarly, the light source IL2 scans a wave number scanning range from a wave number k₂₁ (=2Π/λ₂₁) to a wave number k₂₂ (=2Π/λ₂₂) between 0 and t₁. The light source IL3 scans a wave number scanning range from a wave number k₃₁ (=2Π/λ₃₁) to a wave number k₃₂ (=2Π/λ₃₂) between 0 and t₁.

The beams L1, L2, and L3 emitted from the light sources IL1, IL2, and IL3 are synthesized by beam splitters 103a and 103b. Thereby, the wavelengths can be simultaneously scanned by the plurality of light sources, and the measurement speed can be maintained.

The synthesized beams L1, L2, and L3 are split by the beam splitter 103b into beams L11, L21, and L31 supplied to a wave number measuring unit 200, and beams L12, L22, and L32 supplied to an interferometer unit 300.

The wave number measuring unit 200 measures the wave numbers at each time of the beams emitted from the light sources IL1, IL2, and IL3 based upon the incident beams L11, L21, and L31, and the obtained wave number measuring data is supplied to the processor 107. The wave number measuring unit 200 may utilize known techniques, such as a wave number measurement utilizing the transmitting light intensity of the Fabry-Perot etalon and a gas cell.

The beams L12, L22, and L32 incident upon the interference unit 300 are split by a beam splitter 103c into reference beams L13, L23, and L33 supplied to a reference surface 101, and target beams L14 L24, and L34 supplied to a target surface 102.

The reference beams L13, L23, and L33 reflected on the reference surface 101 and the target beams L14, L24, and L34 back-scattered on the target surface 102 are synthesized by the beam splitter 103c. The synthesized beam is received by an optical detector 106, such as a photodiode, and detected as an interference signal S100 in which a plurality of types of interference patterns corresponding to the plurality of types of beams. The interference signal S100 varies with time. The interference signal S100 is an interference signal made by summing up a first interference signal S10, a second interference signal S20, and a third interference signal S30.

The first interference signal S10 is an interference signal formed by the interference between the reference beam L13 and the target beam L14. The second interference signal S20 is an interference signal formed by the interference between the reference beam L23 and the target beam L24. The third interference signal S30 is an interference signal formed by the interference between the reference beam L33 and the target beam L34.

The interference signals S10, S20, and S30 are interference signals in the wavelength scanning ranges of the beams emitted from the light sources IL1, IL2, and IL3. The prior art cannot separate the interference signals S10, S20, and S30 from the interference signal S100, and thus requires individual optical detectors. Accordingly, this embodiment can set the separable wavelength scanning speed.

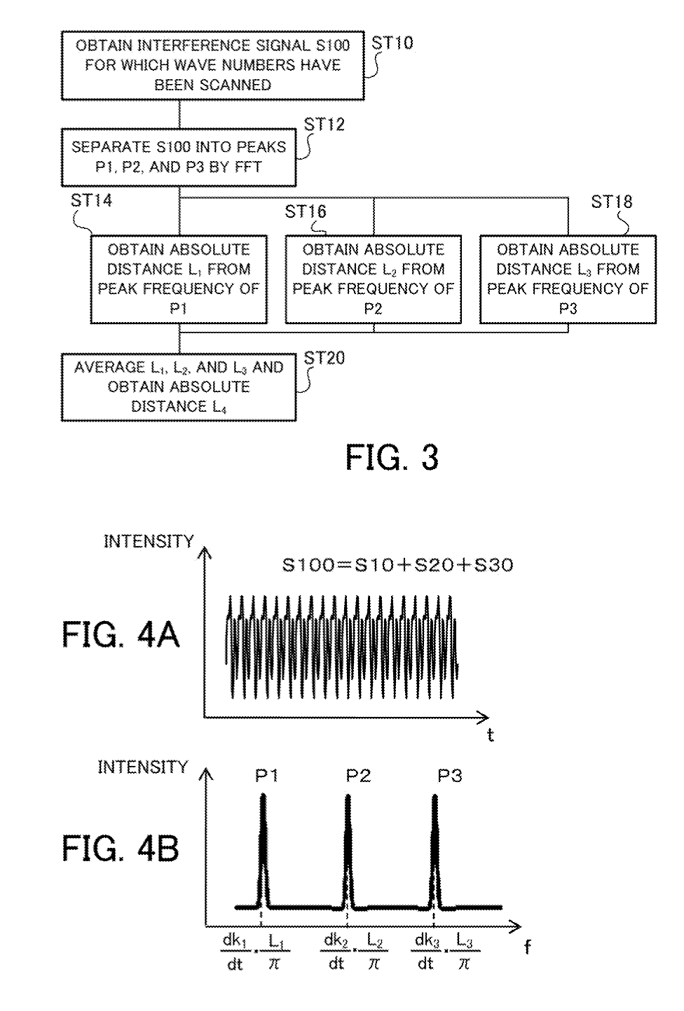

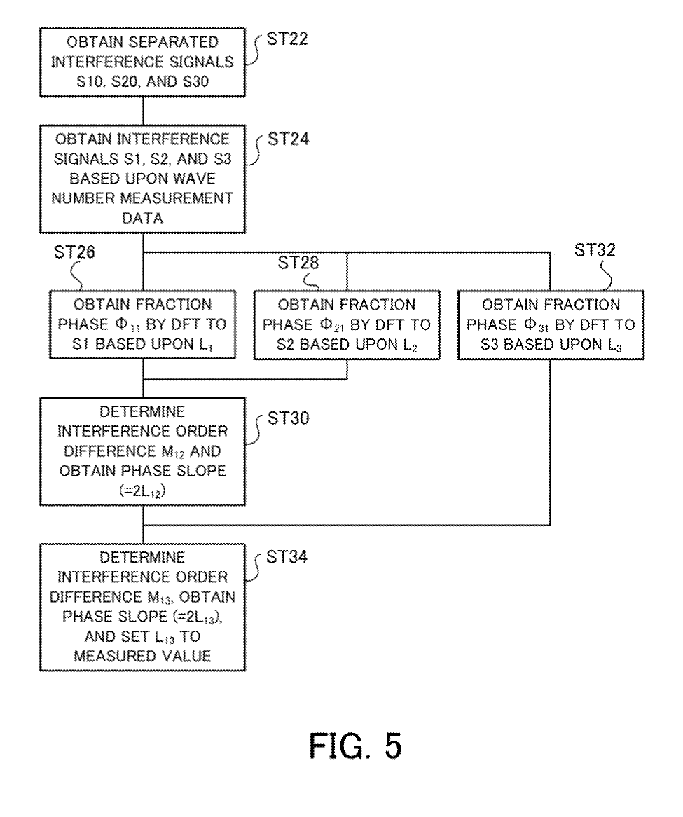

FIG. 3 is a flowchart for explaining an operation of the processor 107 necessary to obtain an absolute distance between the reference surface 101 and the target surface 102. The processor 107 calculates the absolute distance between the reference surface 101 and the target surface 102 based upon the interference signal S100 that varies with time in accordance with the flowchart illustrated in FIG. 3. In the flowchart illustrated in FIG. 3, “ST” stands for the step, and this flowchart is implemented as a program that enables a computer to execute each step. This is true of FIG. 5, which will be described later.

Initially, the processor 107 obtains from the optical detector 106 the interference signal S100 for which the wave numbers have been scanned (ST10). Next, the processor 107 performs the FFT for the interference signal S100 for a frequency analysis and resolves the spectrum of peaks P1, P2, and P3 corresponding to the interference signals S10, S20, and S30 (ST12). The spectrum cannot be resolved in the prior art because the wavelength scanning speeds are approximately equal to one another.

The interference signals S10, S20, S30, and S100 are expressed by the following expressions for time t:

S10(t)=A₁²+B₁²+A₁B₁ cos(2Lk₁(t))

S20(t)=A₂²+B₂²+A₂B₂ cos(2Lk₂(t))

S30(t)=A₃²+B₃²+A₃B₃ cos(2Lk₃(t))

S100(t)=S10(t)+S30(t)+S20(t) Expressions 1

A₁, A₂, and A₃ are amplitude intensities of the reference beams L13, L23, and L33, and B₁, B₂, and B₃ are amplitude intensities of the target beams L14, L24, and L34. k₁, k₂, and k₃ are wave numbers of the beams emitted from the light sources IL1, IL2, and IL3 at time t, and L is an absolute distance. For simplicity purposes, assume that the space has a refractive index of 1 and there is no dispersions.

FIG. 4A illustrates the interference signal S100 that varies with time where an abscissa axis denotes time t and an ordinate axis denotes a signal intensity. FIG. 4B illustrates the result of the FFTed interference signal S100 where an abscissa axis denotes a frequency f and an ordinate axis denotes an intensity.

The wave numbers k₁, k₂, and k₃ are scanned at speeds different from each other, and the interference signals S10, S20, and S30 have frequency components different from each other. Sufficiently different scanning speed among the wave numbers k₁, k₂, and k₃, enable the peaks P1, P2, and P3 to be separated in their wave number scanning ranges as illustrated in FIG. 4B by Fourier-transforming the interference signal S100.

The scanning speeds are set different from one another among the wave numbers k₁, k₂, and k₃ so that the peaks P1, P2, and P3 can be separated. For example, the peak frequency differences of the peaks P1, P2, and P3 may be set larger than the half-value frequency width.

Next, the processor 107 obtains an absolute distance L₁ from the (peak) frequency corresponding to the separated peak P1 (ST14). Similarly, the processor 107 obtains an absolute distance L₂ from the (peak) frequency corresponding to the separated peak P2 (ST16), and an absolute distance L₃ from the (peak) frequency corresponding to the separated peak P3 (ST18). Thus, the processor 107 obtains the absolute distances L₁, L₂, and L₃ for the plurality of types of beams L12, L22, and L32 through the frequency analysis of the synthesized interference signal S100, and outputs one absolute value L₄ by operating the plurality of obtained absolute distances. The operation is not limited, and may be a simple average, a weighted average, or a phase connection, which will be described later with reference to FIGS. 5 to 8.

Next, the processor 107 obtains the absolute distance L₄ by averaging the absolute distances L₁, L₂, and L₃ (ST20). When the absolute distance is obtained from the peak frequency, as reported in literature 1, the measurement precision of about 1/100 times as high as a pitch of the FFTed discrete data (“FFTed pitch” hereinafter).

Similar to JP 2008-128707, the effective wave number scanning range can be widened by obtaining the absolute distances from the three peak frequencies, and thereby the measurement precision of the absolute distance can be improved. JP 2008-128707 requires optical detectors of the same number as the wave number scanning ranges to detect the interference signals S10, S20, and S30, whereas this embodiment can improve the precision with the single optical detector by scanning the wave number scanning ranges at different speeds. The interference signals S10, S20, and S30 can be separated from the interference signal S100 by performing the inverse fast Fourier transform for the separate peaks.

FIG. 5 is a flowchart for explaining an operation necessary to more precisely obtain the absolute distance between the reference surface 101 and the target surface 102 than the absolute distance L₄.

Initially, the processor 107 performs inverse fast Fourier transform (IFFT) for the separated peaks and obtains the separated interference signals S10, S20, and S30 (ST22).

Next, the processor 107 converts the interference signals S10, S20, and S30 that vary with time into first interference signal S1, second interference signal S2, the third interference signal S3 that vary with the wave number, based upon wave number measurement data supplied from the wave number measuring unit 200 (ST24).

The interference signal S1 is expressed by a function of the wave number k as follows, where Φ′ is a phase of the interference signal, M is an order of interference, and Φ is a fraction component of a phase of the interference signal contained in the range of ±Π (referred to as a “fraction phase” hereinafter).

$$\begin{matrix}S 1 ( k ) = {A}_{1}^{2} + {B}_{1}^{2} + {A}_{1} {B}_{1} cos ( {φ}^{′} ) & Expression 2 \\ \begin{matrix}{φ}^{′} = 2 kL \\ = 2 π M + φ\end{matrix} & \end{matrix}$$

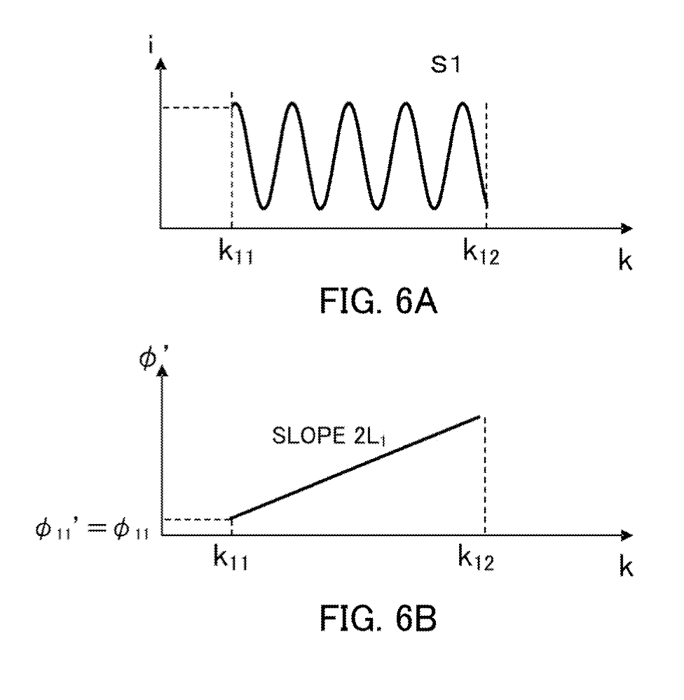

FIG. 6A illustrates a relationship between the wave number k (abscissa axis) and the intensity i (ordinate axis) of the first interference signal S1. FIG. 6B illustrates a relationship between the wave number k (abscissa axis) and the phase Φ′ (ordinate axis) of the first interference signal S1. Since the wave number k is a relative value, the phase Φ′ is based upon a phase for the wave number k₁₁.

As illustrated in Expression 2, a double (2L₁) of the absolute distance L₁ corresponds to a slope of the phase Φ′ of the first interference signal S1 for the wave number k illustrated in FIG. 6B. Since the interference signals S1, S2, and S3 have signal intensities illustrated in FIG. 6A, the phase of the interference signal is determined based upon the signal intensity and the following discrete Fourier transform (“DFT”):

Accordingly, the processor 107 determines the fraction phase of the first interference signal S1 for an arbitrary wave number k in the range from the wave number k₁₁ to the wave number k₁₂ by performing the DFT for the first interference signal S1 utilizing the absolute distance L₁ obtained in ST14 (ST26). Now, in an example, the fraction phase Φ₁₁ is determined for the wave number k₁₁ as the fraction phase of the first interference signal S1 (fraction component of the first phase).

The fraction phase Φ is calculated in accordance with Expression 3:

$$\begin{matrix}φ ( k ) = {tan}^{- 1} \frac{{\sum }_{j}^{ } S 1 ( j ) sin \{ 2 {L}_{1} ( j - k ) \}}{{\sum }_{j}^{ } S 1 ( j ) cos \{ 2 {L}_{1} ( j - k ) \}} & Expression 3 \\ j = {k}_{11} ∼ {k}_{12} & \end{matrix}$$

Due to Expression 3, a fraction phase of the first interference signal S1 (fraction component of first phase) can be determined for an arbitrary wave number, such as the fraction phase Φ₁₁ for the wave number k₁₁ and the fraction phase Φ₁₂ for the wave number k₁₂. The fraction phase Φ determined by Expression 3 is located only in the range of ±Π, and the order of interference is unknown.

Since the slope of the phase Φ′ of the interference signal S1 is known as 2L₁, the phase Φ′ can be expressed as illustrated in FIG. 6B on the basis of the fraction phase Φ₁₁ for the wave number k₁₁. Hereinafter, assume that a phase without a prime (′) such as the fraction phase Φ₁₁ is located in the range of ±Π and a phase with a prime such as Φ′₁₁ is a relative phase that is based upon Φ₁₁. While the phase Φ′ is based upon the fraction phase Φ₁₁ for the wave number k₁₁ in this embodiment, a phase for an arbitrary wave number may be used for a basis.

The absolute distance L₁ obtained in ST14 has an error to a true value of the absolute distance. The precision of the absolute distance L₁ becomes the precision of about 1/100 of the FFTed pitch due to a signal processing technique reported in literature 1, appropriate zero padding in the FFT, or the like.

Since the slope of the phase of the interference signal S1 for the wave number k is 2L₁, the precision of the fraction phase Φ calculated in accordance with Expression 3 when the calculation precision of the absolute distance is 1/100 of the FFTed pitch becomes 2Π/100 or smaller in the overall wave number scanning range.

A method for determining the absolute distance illustrated in FIG. 3 can provide an absolute distance (a slope of a phase) having a precision improved by the FFT and averaging. On the other hand, the slope of the phase and the fraction phase for an arbitrary wave number can be obtained by adding the processing illustrated in FIG. 5 based upon one interference signal for the wave numbers.

Similarly, the processor 107 determines the fraction phase of the second interference signal S2 (fraction component in the second phase) for the arbitrary wave number by performing the DFT for the second interference signal S2 in the range from the wave number k₂₁ to the wave number k₂₂ utilizing the absolute distance L₂ obtained in S16 (ST28). Now, in one example, assume that the fraction phase Φ₂₁ for the wave number k₂₁ is determined as the second fraction phase of the second interference signal S2.

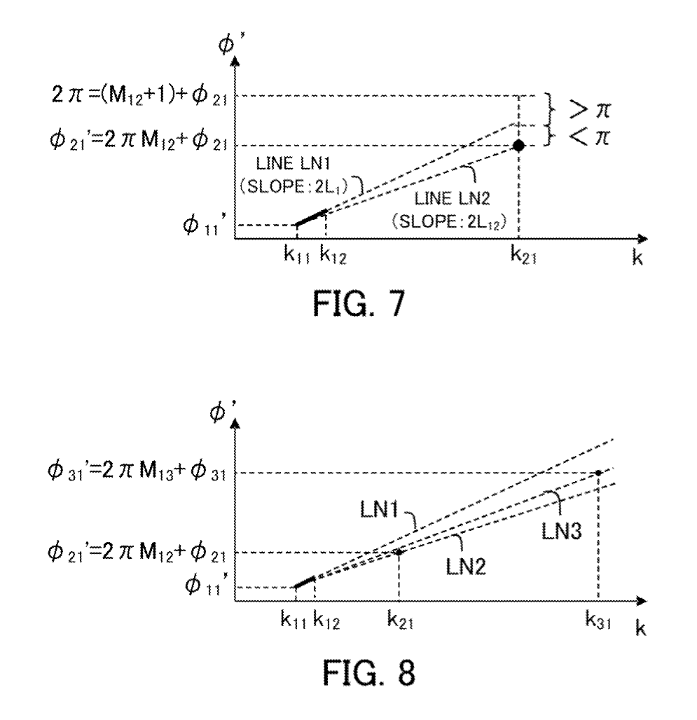

Referring now to FIG. 7, a description will be given of a method for determining the slope of the phase 2L₁₂ (ST30). A line LN1 is determined by the phase Φ₁₁ of the interference signal S1 for the wave number k₁₁ determined in ST26 and the slope of the phase 2L₁. A line LN2 is a line determined by the phase Φ′₂₁ expressed by (2ΠM₁₂+Φ₂₁) and the phase Φ′₁₁. M₁₂ is a (first) interference order difference between the interference signal S1 for the wave number k₁₁ and the interference signal S2 for the wave number k₂₁, and determined by Expression 4:

$${M}_{12} = round \{ \frac{2 {L}_{1} ( {k}_{21} - {k}_{11} ) + {φ}_{11} - {φ}_{21}}{2 π} \} \qquad Expression 4$$

“round( )” means a function that rounds an augment into an integer. In order correctly find M₁₂, the inequality in Expression 5 needs to be satisfied:

$$\frac{δφ ( {k}_{21} - {k}_{11} )}{( {k}_{12} - {k}_{11} )} < π \qquad Expression 5$$

δΦ represents a phase error. It is understood from Expression 5 that as a phase error δΦ becomes smaller, a difference between k₂₁ and k₁₁ or a discrete interval of the wavelength scanning range between IL1 and IL2 can be made larger. As described above, the phase error δΦ is set to a value less than 2Π/100, (k₂₁-k₁₁) needs to be equal to or less than five times as many as (k₁₂-k₁₁) so as to maximizing the effect in view of Expression 5.

Since the processor 107 calculates the fraction phase Φ₂₁ in ST28, the absolute distance L₁₂ can be calculated from the slope 2L₁₂ (second slope) of the line LN2 as in Expression 6 by determining the first interference order difference with Expression 4:

$$\begin{matrix}{L}_{12} = \frac{1}{2} \frac{{φ}_{21}^{′} - {φ}_{11}^{′}}{{k}_{21} - {k}_{11}} \\ = \frac{1}{2} \frac{2 π {M}_{12} + {φ}_{21} - {φ}_{11}}{{k}_{21} - {k}_{11}}\end{matrix} \qquad Expression 6$$

The absolute distance L₁₂ calculated from Expression 6 has a more improved precision (or error) than (k₂₁-k₁₁)/(k₂₁-k₁₁) of the absolute distance L₁ calculated in FIG. 3. This means that by determining the first interference order difference M₁₂, a phase in the wave number scanning range from k₁₁ to k₁₂ can be connected to a phase for the wave number k₂₁ and the precision of the absolute distance can be improved as if the wave number scanning range from k₁₁ to k₂₁ is scanned.

Next, the processor 107 determines a fraction phase of a third interference signal S3 similar to ST26 (ST32). More specifically, in ST32, a fraction phase for an arbitrary wave number k (fraction component of a third phase) in a wavelength scanning range from the wave number k₃₁ to the wave number k₃₂ is determined based upon the third interference signal S3 and the absolute distance L₃. Now, in an example, assume that the fraction phase Φ₃₁ for the wave number k₃₁ is calculated as the fraction phase of the third interference signal S3.

Next, the processor 107 determines a (second) interference order difference M₁₃ between the interference signal for the wave number k₁₁ and the interference signal for the wave number k₃₁ similar to ST30 (ST34). The interference order difference M₁₃ is defined by Expression 7:

In order to correctly find the second interference order difference M₁₃, the inequalities of Expressions 8 needs to be satisfied. Since a line LN3 illustrated in FIG. 8 can be determined by determining the interference order difference M₁₃, the absolute distance L₁₃ can be calculated in accordance with Expression 9:

$$\begin{matrix}{M}_{13} = round \{ \frac{2 {L}_{2} ( {k}_{31} - {k}_{11} ) + {φ}_{11} - {φ}_{31}}{2 π} \} & Expression 7 \\ \frac{δφ ( {k}_{31} - {k}_{11} )}{( {k}_{21} - {k}_{11} )} < π & Expressions 8 \\ \frac{δφ ( {k}_{31} - {k}_{11} )}{50 ( {k}_{12} - {k}_{11} )} < π & \\ \begin{matrix}{L}_{13} = \frac{1}{2} \frac{{φ}_{31}^{′} - {φ}_{11}^{′}}{{k}_{31} - {k}_{11}} \\ = \frac{1}{2} \frac{2 π {M}_{13} + {φ}_{31} - {φ}_{11}}{{k}_{31} - {k}_{11}}\end{matrix} & Expression 9\end{matrix}$$

From Expression 8, (k₃₁-k₁₁) can be increased up to a maximum value that is 50 times as many as (k₂₁-k₁₁) or 2500 times as many as (k₁₂-k₁₁).

The absolute distance L₁₃ calculated in accordance with Expression 9 can have an improved precision of 1/50 of the absolute distance L₁₂ or 1/2500 of the absolute value of L₁. In other words, a discrete interval between the wave number scanning range by IL1 or IL2 and the wave number scanning range by IL3 can be larger than a discrete interval between the wave number scanning range by IL1 and the wave number scanning range by IL2, and the precision can be exponentially improved by the number of wave number scanning ranges.

When there are N (which is three or more in this embodiment) wave number scanning ranges, a discrete interval between (i−1)-th wave number scanning range and the i-th wave number scanning range may be set larger than a discrete interval between (i−2)-th wave number scanning range and the (i−1)-th wave number scanning range.

As discussed, the measuring apparatus 100 utilizes a plurality of wave number scanning ranges to widen the effective wave number scanning range, and to highly precisely obtain an absolute distance between the reference surface 101 and the target surface 102 with a simple structure utilizing a single optical detector.

The method of FIG. 5 calculates a fraction phase utilizing the DFT and the absolute distances L₁, L₂, and L₃ for the interference signals S1, S2, and S3, but the fraction phase can be similarly calculated by performing the DFT for the interference signal S100 and by considering the difference of the wave number scanning speed. While this embodiment utilizes three light sources (N=3), the number of light sources may be increased or decreased in accordance with necessary precisions.

For example, assume that a plurality of wave number scanning ranges are N wave number scanning ranges (where N is an integer equal to or larger than 4). The processor 107 determines the fraction component of the i-th phase that is the phase of the i-th interference signal for the arbitrary wave number contained in the i-th wave number scanning range based upon the (i−1)-th interference signal for the i-th wavelength scanning range detected by the interferometer unit 300. The processor 107 determines an (i−1)-th interference order difference that is an interference order difference between the first phase and the i-th phase based upon the (i−1)-th slope of the phase. The processor 107 determines the i-th slope of the phase that is the slope of the phase of the interference signal that contains the first interference signal to the i-th interference signal based upon the (i−1)-th interference order difference, the fraction component of the first phase, and the fraction component of the i-th phase. The processor repeats the above procedures from i=3 to i=N by incrementing i by 1. Thereby, the processor 107 determines the N-th slope of the phase, and the absolute distance from the N-th slope of the phase. In this case, as described above, the discrete interval between the (i−1)-th wavelength scanning range and the i-th wavelength scanning range can be set larger than the discrete interval between the (i−1)-th wavelength scanning range and the (i−2)-the wavelength scanning range.

This embodiment considers negligible the wave number measuring error in the wave number measuring unit, but when it is not negligible, the discrete interval may be made smaller so that the interference order difference can be determined. Alternatively, the discrete interval of each wavelength scanning range can be adjusted by the target surface 102 and the measuring environment. In this case, since a high-speed adjustment is perhaps unnecessary, the wavelength scanning range may be adjusted, for example, by changing the temperature of the VCSEL. While this embodiment utilizes the FFT for the frequency analysis, another known frequency analyzing method such as a maximum entropy method may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-204336, filed Sep. 20, 2011 which is hereby incorporated by reference herein in its entirety.

What is claimed is:

1. A measuring apparatus configured to measure an absolute distance between a reference surface and a target surface, said measuring apparatus comprising:
a light source unit configured to continuously scan wavelengths of a plurality of types of beams at different speeds in a plurality of discrete wavelength scanning ranges;
a beam synthesizer configured to synthesize the plurality of types of beams emitted from the light source unit;
an interferometer unit configured to split the beam synthesized by the beam synthesizer into a reference beam and a target beam and to detect as an interference signal an interference fringe formed by the reference beam reflected on a reference surface and the target beam reflected on a target surface; and
a processor configured to determine the absolute distance based upon the interference signal detected by the interferometer unit,
wherein the interferometer unit includes a single optical detector configured to detect each of a plurality of types of interference fringes corresponding to the plurality of types of beams, in a synthesized interference signal, and
wherein the processor obtains the absolute distance for each of the plurality of types of beams through a frequency analysis of the synthesized interference signal, and outputs one absolute distance by operating a plurality of absolute distances that have been obtained.

2. The measuring apparatus according to claim 1, wherein the processor is further configured to:
determine, based upon a first interference signal detected by the interferometer unit in a first wavelength scanning range that is one of the plurality of wavelength scanning ranges, a first slope that is a slope of a phase of the first interference signal for a wave number of the beam and a fraction component of the first phase that is the phase of the first interference signal for an arbitrary wave number contained in the first wavelength scanning range;
determine, based upon a second interference signal detected by the interferometer unit in a second wavelength scanning range that is one of the plurality of wavelength scanning ranges, a fraction component of a second phase that is a phase of the second interference signal for an arbitrary number contained in the second wavelength scanning range;
determine a first interference order difference that is a difference of an order of interference between the first phase and the second phase based upon the first slope, the fraction component of the first phase, and the fraction component of the second phase; and
determine a second slope that is a slope of a phase of an interference signal for a wave number of the beam, which contains the first interference signal and the second interference signal based upon the first interference order difference, the fraction component of the first phase, and the fraction component of the second phase.

3. The measuring apparatus according to claim 2, wherein the processor calculates the slope of the phase of the first interference signal through the frequency analysis of the first interference signal, and calculates the first phase by utilizing the slope of the phase of the first interference signal and a discrete Fourier transform of the first interference signal.

4. The measuring apparatus according to claim 2, wherein the plurality of wavelength scanning ranges are three wavelength scanning ranges, and
wherein the processor is further configured to:
determine, based upon a third interference signal detected by the interferometer unit for a third wavelength scanning range, a fraction component of a third phase that is a phase of a third interference signal for an arbitrary wave number contained in the third wavelength scanning range;
determine a second interference order difference that is an interference order difference between the first phase and the third phase based upon the second slope;
determine a third slope that is a slope of a phase of an interference signal for a wave number of the beam, which contains the first interference signal to the third interference signal based upon the second interference order difference, the fraction component of the first phase, and the fraction component of the third phase; and
determine the absolute distance from the third slope.

5. The measuring apparatus according to claim 2, wherein the plurality of wavelength scanning ranges are N wavelength scanning ranges, N being an integer equal to or larger than four, and
wherein the processor is further configured to repeat steps from i=3 to i=N by incrementing i by 1 so as to determine a N-th slope of a phase and to determine the absolute distance based upon the N-th slope, and
wherein the steps include:
determining, based upon an (i−1)-th interference signal detected by the interferometer unit for an i-th wavelength scanning range, a fraction component of an i-th phase that is a phase of an i-th interference signal for an arbitrary wave number contained in the i-th wavelength scanning range;
determining an (i−1)-th interference order difference that is an interference order difference between the first phase and the i-th phase based upon a (i−1)-th slope; and
determining a i-th slope that is a slope of a phase of an interference signal for a wave number of the beam, which contains the first interference signal to the i-th interference signal based upon the (i−1)-th interference order difference, the fraction component of the first phase, and the fraction component of the i-th phase.

6. The measuring apparatus according to claim 5, wherein a discrete interval between an (i−1)-th wavelength scanning range and the i-th wavelength scanning range is larger than a discrete interval between the (i−1)-th wavelength scanning range and an (i−2)-th wavelength scanning range.
